(19) United States
(12) Patent Application Publication
(10) Pub. No.: US 2008/0214052 A1
(43) Pub. Date: Sep. 4, 2008

(54) Connector device

(75) Inventor: Chang-Yi Li, Taoyuan County (TW)

Correspondence Address: TROXELL LAW OFFICE PLLC, 5205 LEESBURG PIKE, SUITE 1404, FALLS CHURCH, VA, 22041, US

(73) Assignee: SPEED TECH CORP., Taoyuan County (TW)

(21) Appl. No.: 11/645,166

(22) Filed: Dec. 26, 2006

(51) Int. Cl. H01R 13/66

(52) U.S. Cl. 439/620.21

(57) ABSTRACT

A connector device is easily fabricated with a saved time and a saved process to obtain a low fabrication cost. The connector device has an H-shaped coil stand to obtain better electromagnetic interfere (EMI) restraining and electronical characteristics

### FIELD OF THE INVENTION

The present invention relates to a connector device; more particularly, relates to fabricating a connector device with saved fabricating time, fabricating process and fabrication cost and with better electromagnetic interference (EMI) restraining and electronical characteristics

### DESCRIPTION OF THE RELATED ART

A general connector device, as shown in FIG. 4, comprises a metal case 6, a USB connector 7 in the metal case 6, and an RJ45 connector 8 piled up with the USB connector 7 in the metal case 6, where the RJ45 connector 8 comprises a circuit board 81, choke coils 82 on the circuit board 81, electrical components 83 on the circuit board 81, and an external terminals seat 84 on the circuit board 81; the choke coil 82 has a circular coil stand 821; the circular coil stand 821 is coiled with a leading wire 822; and the connector device is electrically connected with external wires through the USB connector 7 and the RJ45 connector 8.

Although the RJ45 connector 8 is connected with an external connector, the choke coil 82 for the RJ45 connector 8 is complex, where, especially for a (high frequency) gigabit Ethernet, a sum of twelve choke coils may be required in a small area for the RJ45 connector 8. Hence, high technology is required and fabrication cost are high with a long fabricating time and a complex fabricating process. Moreover, cross talk, return loss and EMI restraining may occur among the choke coils so that electronical characteristics of the connector device become worse. Hence, the prior art does not fulfill users' requests on actual use.

### SUMMARY OF THE INVENTION

The main purpose of the present invention is to fabricate a connector device with saved fabricating time, fabricating process and fabrication cost and with better EMI restraining and electronical characteristics

To achieve the above purpose, the present invention is a connector device having an H-shaped coil stand comprising a metal case having openings on an end surface; a first connecting unit in the metal case corresponding to an opening case; and a second connecting unit in the metal case corresponding to another opening, where the second connecting unit is piled up and fixed with the first connecting unit; the second connecting unit has a circuit board; the circuit board has at least one set of components corresponding to each other; the components comprises a choke unit, a terminals seat and external terminals; the circuit board has at least one choke unit comprising an H-shaped coil stand and a leading wire; and the leading wire is coiled around the H-shaped coil stand and is connected with the circuit board. Accordingly, a novel connector device having an H-shaped coil stand is obtained.

### BRIEF DESCRIPTIONS OF THE DRAWINGS

The present invention will be better understood from the following detailed description of the preferred embodiment according to the present invention, taken in con junction with the accompanying drawings, in which

FIG. 1 is the front view showing the preferred embodiment according to the present invention;

FIG. 2 is the perspective view showing the preferred embodiment;

FIG. 3 is the view showing the state of use of the preferred embodiment; and

FIG. 4 is the perspective view of the prior art.

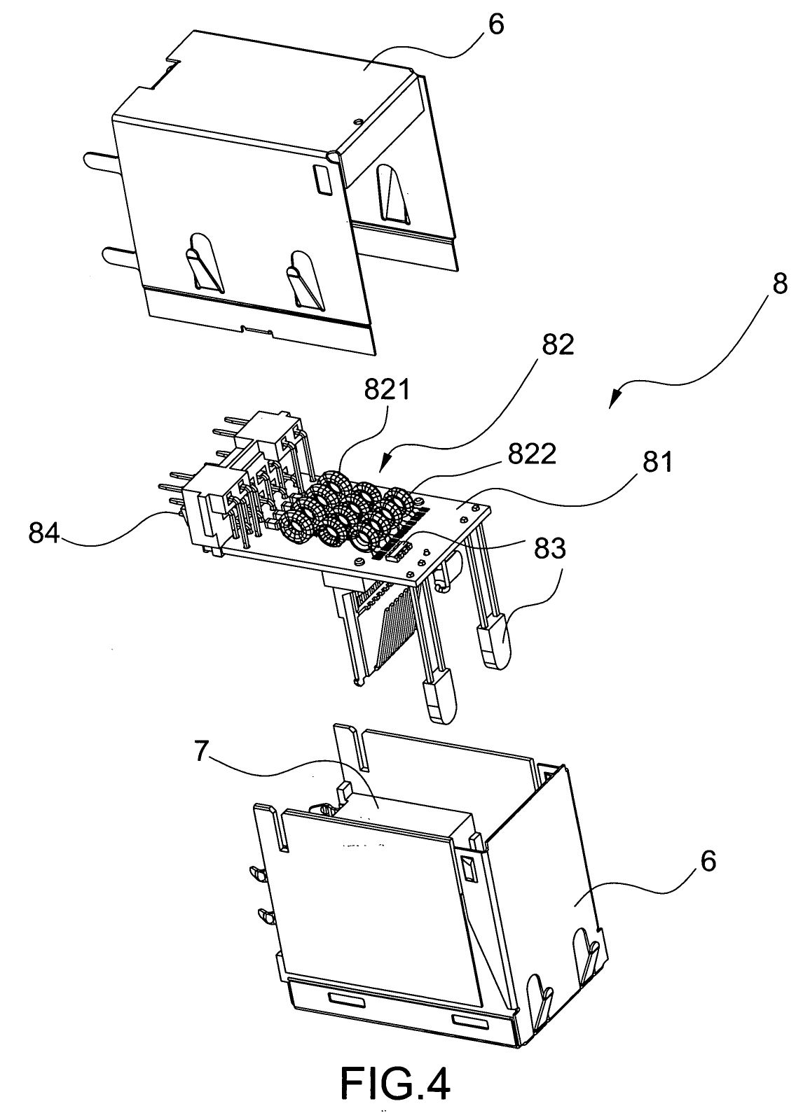

### DESCRIPTION OF THE PREFERRED EMBODIMENT

The following description of the preferred embodiment is provided to understand the features and the structures of the present invention.

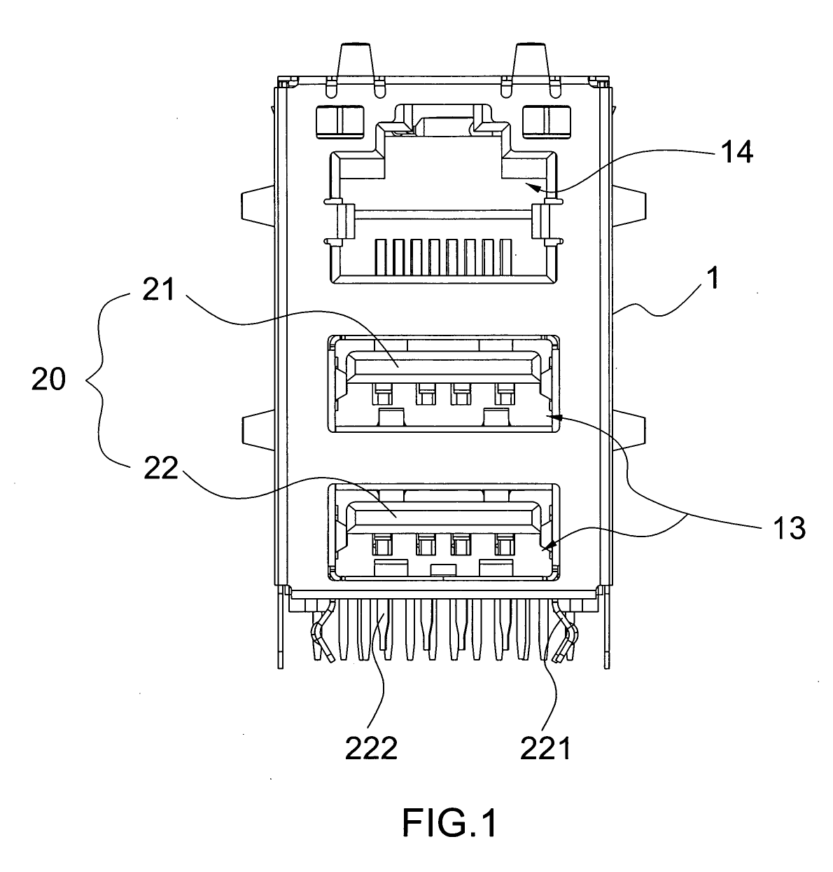

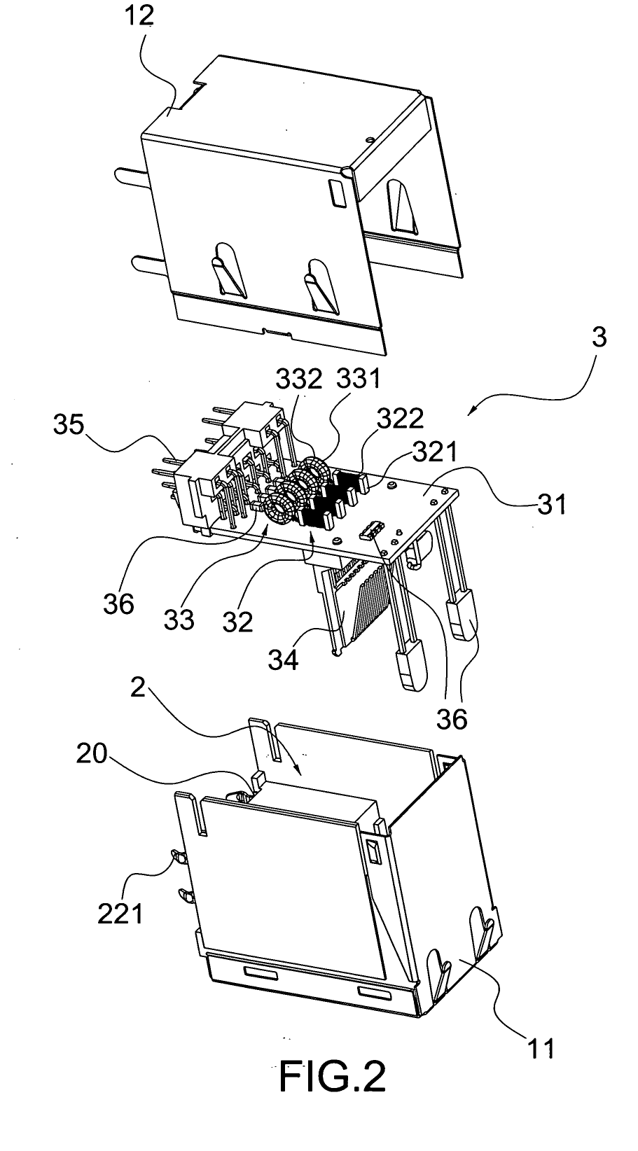

Please refer to FIG. 1 and FIG. 2, which are a front view and a perspective view showing the preferred embodiment according to the present invention. As shown in the figures, the present invention is a connector device having an H-shaped coil stand, comprising a metal case 1, a first connecting unit 2 and a second connecting unit 3.

The metal case 1 comprises two covers 11,12; and has a plurality of openings 13,14 on an end surface.

The first connecting unit 2 is located in the metal case 1; and is corresponding to at least one of the openings 13. The first connecting unit 2 has at least one insulated shell 20. The insulated shell 20 has a plurality of connectors 21,22 piled up; and has a plurality of connecting terminals 221,222 at bottom. The insulated shell 20 is conformed to an insulated shell standard for an USB connector.

The second connecting unit 3 is located in the metal case 1; and is corresponding to at least another one of the openings 14. The second connecting unit 3 is piled up and fixed with the first connecting unit 2; and has a circuit board 31. The circuit board 31 has several sets of components corresponding to each other, where the components comprise a choke unit 32,33, a terminals seat 34, external terminals 35 and electrical components 36. The circuit board 31 comprises a first choke unit 32, which comprises an H-shaped coil stand 321 and a leading wire 322 that is coiled around the H-shaped coil stand 321 and is connected to the circuit board 31. The circuit board 31 further comprises a second choke unit 33, which comprises a circular coil stand 331 and another leading wire 332 that is coiled around the circular coil stand 331 and is connected to the circuit board 31. Thus, a novel connector device having an H-shaped coil stand is obtained, where, on fabricating the connector device, the circuit board 31 and the choke units 32,33 are designed to save fabricating time, fabricating process and fabrication cost.

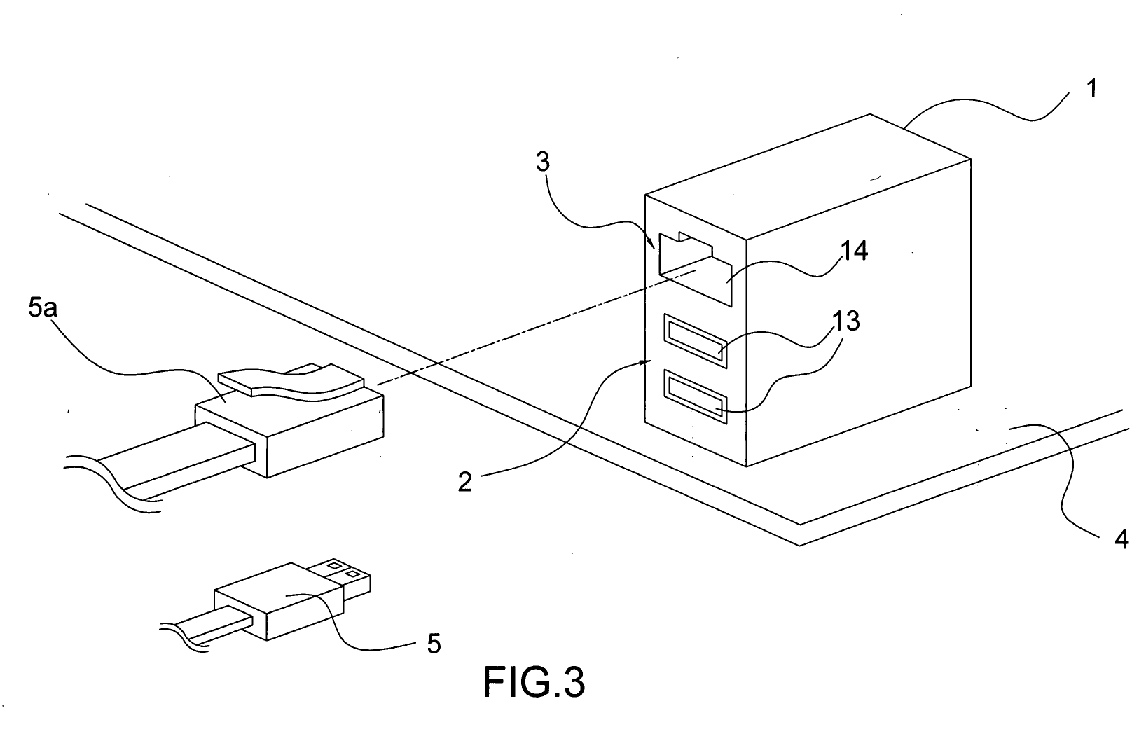

Please refer to FIG. 3, which is a view showing a state of use of the preferred embodiment. As shown in the figure, connecting terminals 221,222 for a first connecting unit 2 and a second connecting unit 3, together with external terminals 35, are connected with a main board 4, where external connectors 5,5a are electrically connected with the first connecting unit 2 and the second connecting unit 3 through openings 13,14 of a metal case 1. When connectors of the first connecting unit 2 and the second connecting unit 3 are connected with the external connectors 5,5a, the present invention obtains better electromagnetic interference (EMI) restraining and electronical characteristics by using choke units 32,33 on a circuit board 31 of the second connecting unit 3.

To sum up, the present invention is a connector device having an H-shaped coil stand, where, on fabricating the connector device, a fabricating time, a fabricating process and a fabrication cost are saved and better EMI restraining and electronical characteristics are obtained.

The preferred embodiment herein disclosed is not intended to unnecessarily limit the scope of the invention. Therefore, simple modifications or variations belonging to the equivalent of the scope of the claims and the instructions disclosed herein for a patent are all with in the scope of the present invention.

What is claimed is:

1. A connector device, comprising:
a metal case, said metal case having a plurality of openings on an end surface of said metal case;
a first connecting unit, said first connecting unit being located in said metal case, said first connecting unit having at least one insulated shell, said first connecting unit being corresponding to one of said openings, said first connecting unit having a plurality of connecting terminals at bottom of said first connecting unit; and
a second connecting unit, said second connecting unit being located in said metal case, said second connecting unit being piled up and fixed with said first connecting unit, said second connecting unit having a circuit board, said circuit board having at least one set of components corresponding to each other, said components comprising a choke unit, a terminals seat and external terminals,
wherein said choke unit comprises an H-shaped coil stand and a leading wire, said leading wire is coiled around said H-shaped coil stand, and said leading wire is connected with said circuit board.

2. The connector device according to claim 1,
wherein said metal case comprises two covers.

3. The connector device according to claim 1,
wherein said H-shaped coil stand is made of an insulated material.

4. The connector device according to claim 1,
wherein said second connecting unit further comprises another choke unit;
wherein said another choke unit comprises a circular coil stand and a leading wire; and
wherein said leading wire is coiled around said circular coil stand and is connected with said circuit board.

5. The connector device according to claim 4,
wherein said circular coil stand is made of an insulated material.
